(19) United States
(12) Patent Application Publication
(10) Pub. No.: US 2001/0017868 A1
(43) Pub. Date: Aug. 30, 2001

(54) Arrangement for generating red, green and blue laser radiation

(75) Inventors: Juergen Kraenert, Jena (DE); Thomas Gabler, Kromsdorf (DE); Holger Zellmer, Magdala (DE); Andreas Tuennermann, Jena (DE)

Correspondence Address: Gerald H. Kiel, Esq., REED SMITH LLP, 375 Park Avenue, New York, NY, 10016-2391, US

(73) Assignee: SCHNEIDER Laser technologies AG;

(21) Appl. No.: 09/792,804

(22) Filed: Feb. 23, 2001

(30) Foreign Application Priority Data
Feb. 29, 2000 (DE) 100 09 381.7

(51) Int. Cl. H01S 3/10

(52) U.S. Cl. 372/23

(57) ABSTRACT

An arrangement which generates red, green and blue laser radiation comprise a laser radiation source whose first beam (λₗ) is split in the infrared wavelength range, wherein the first part of this beam is frequency-doubled and green light (λ_{G}) results and another part is used to generate light of the primary colors red (λ_{R}) and blue (λ_{B}). Another part of the first beam (λₗ) is fed to a wavelength converter which generates another beam (λ₂, λ₄) in the infrared wavelength range which has a greater wavelength than the first beam (λₗ), further, the colors red (λ_{R}) and blue (λ_{B}) result from the further beam (λ₂, λ₄) or from a part thereof by another nonlinear process by sum frequency mixing or by frequency doubling or by sum frequency mixing and frequency doubling.

### BACKGROUND OF THE INVENTION

a) Field of the Invention

The invention is directed to an arrangement which generates red, green and blue light from laser radiation in the infrared wavelength range. The red, green and blue light is used particularly for showing color images.

b) Description of the Related Art

Generation of light in the primary colors is known from DE 44 32 029 C2, DE 197 13 433 C1, DE 195 04 047 C1, U.S. Pat. No. 5,740,190 A and EP 0 788 015 A2, all of which use an IR laser whose radiation or frequency-doubled radiation is fed, at least in part, to an optical parametric oscillator (OPO). By means of the signal beam and/or idler beam emitted from the optical parametric oscillator, the light is generated in red, green and blue by the additional steps of sum frequency mixing and/or frequency doubling. U.S. Pat. No. 5,295,143 A describes a three color laser in which two Ti:S lasers are pumped by a frequency-doubled infrared laser. The Ti:S lasers supply the colors red and blue. The frequency-doubled infrared laser supplies green.

OBJECT AND SUMMARY OF THE INVENTION

The primary object of the invention is to provide an arrangement for generating RGB laser radiation in which technological expenditure is reduced. Further, the laser radiation is to be generated in the three primary colors with stable quality parameters.

The invention is directed to an arrangement for generating red, green and blue laser radiation comprising a laser radiation source whose infrared beam is split, wherein the first part of this beam is frequency-doubled and green light results and another part is used to generate light of another primary color. Another part of the first beam is fed to a wavelength converter which generates another beam (λ₂, λ₄) in the infrared wavelength range which has a greater wavelength range than the first beam (λ). The colors red (λ_{R}) and blue (λ_{B}) result from the further beam (λ₂, λ₄) or from a part thereof by another nonlinear process by sum frequency mixing or by frequency doubling or by sum frequency mixing and frequency doubling.

The invention consists, in particular, in that a second part of the first laser beam is converted by a wavelength converter operating on the basis of stimulated Raman scattering (SRS) into laser radiation with greater wavelengths which are then used to generate the colors red and blue by sum frequency mixing and/or frequency doubling.

In a first case, the invention is characterized in that a second part of the original beam is shifted in the range of 1.4 to 1.6 μm by means of the Raman wavelength converter, this wavelength-shifted beam is fed with a third part of the original beam to a first sum frequency mixing and the color red results; further, a second part of the shifted beam is frequency doubled and the frequency-doubled beam is fed with a fourth part of the original beam to a second sum frequency mixing and blue light results.

In a second case, the invention is characterized in that the beam that is Raman-shifted in the wavelength range between 1.4 and 1.6 μm is split, wherein a first part of the wavelength-shifted beam is supplied with a third part of the original beam to a first sum frequency mixing and red light results, this red light is split, and, further, a second part of the shifted beam with a part of the red light is supplied to a further sum frequency mixing and blue light results.

In a third case, the invention is characterized in that a part of the original laser beam is only Raman-shifted up to the wavelength range between 1.2 and 1.4 μm, and the remaining part is again shifted in the wavelength range between 1.4 and 1.6 μm, the part that is shifted in the wavelength range between 1.2 and 1.4 μm is frequency doubled, and the color red results, further the part of the beam which is shifted in the wavelength range between 1.4 and 1.6 μm is frequency doubled, this frequency-doubled beam is supplied with a third part of the original beam to a sum frequency mixing and blue light results.

In a fourth case, the invention is characterized in that a part of the original laser beam is only Raman-shifted up to the wavelength range between 1.2 and 1.4 μm, and the remaining part is again Raman-shifted in the wavelength range between 1.4 and 1.6 μm, the part that is shifted in the wavelength range between 1.2 and 1.4 μm is frequency doubled, and the color red results, this red light is split, the part of the beam that is shifted in the range of 1.4 to 1.6 μm is supplied with a part of the red light to another sum frequency mixing and blue light results.

In every case, the laser radiation source emits light of the wavelength in the range of 1.0 to 1.1 μm.

In accordance with the state of the art, the laser radiation source is a solid state laser or a neodymium-(Nd-) or ytterbium-(Yb-)based fiber laser or a diode laser. In particular, a Nd:YAG laser, Nd:YLF laser or Nd:YO₄ laser is used as solid state laser. However, any other type of laser radiation source delivering the required parameters, i.e., beam output, divergence of laser beams, low noise and a wavelength in the indicated wavelength range, can also be used.

The nonlinear media for frequency doubling and sum frequency mixing can be a nonlinear crystal or a periodically poled structure.

The laser is advantageously a pulsed laser, particularly a mode-locked laser supplying individual pulses at a pulse repetition frequency up to the MHz range. Typical pulse repetition frequencies for applications for image display are 100 Hz, 32 kHz or greater than 50 MHz, wherein a pulse width in the range of 0.1 ps to 10 ps should be generated for displaying images. A condition for the use of a pulsed laser consists in that the pulses collide synchronously in the nonlinear medium for sum frequency mixing, i.e., they must coincide or at least partially overlap in geometric and temporal dimensions and there must be phase matching.

The laser radiation source can also be a continuous-wave laser. With this configuration, the temporal overlap is given automatically.

As a result of the invention, it is possible to make do with a comparatively small number of component elements to generate the three primary colors.

A desired splitting of energy in the individual beam paths for generating red, green and blue in the desired intensity ratio can be carried out by means of splitting mirrors having a determined splitting ratio.

The invention will be described in the following with reference to the drawings.

### BRIEF DESCRIPTION OF THE DRAWINGS

In the drawings:

FIG. 1 shows an R-G-B laser radiation source with a Raman wavelength converter (SRS) and four crystals for wavelength transformation;

FIG. 2 shows an R-G-B laser radiation source with a Raman wavelength converter (SRS) and three crystals for wavelength transformation;

FIG. 3 shows an R-G-B laser radiation source with two Raman wavelength converters and four crystals for wavelength transformation;

FIG. 4 shows an R-G-B laser radiation source with two Raman wavelength converters and three crystals for wavelength transformation; and

FIG. 5 shows an R-G-B laser radiation source with a Raman wavelength converter which is operated on two wavelengths.

### DESCRIPTION OF THE PREFERRED EMBODIMENTS

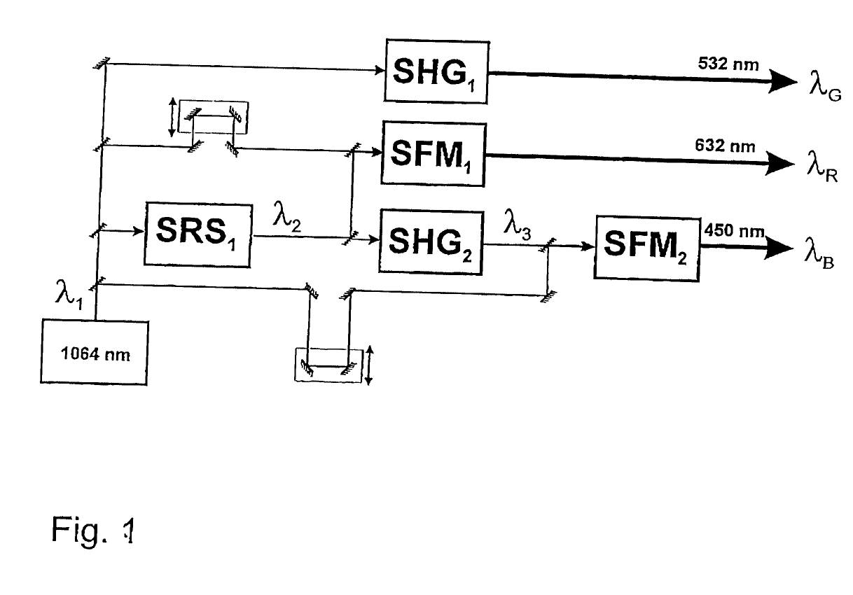

FIG. 1 shows a first construction of an R-G-B laser radiation source according to the invention. On the one hand, it comprises a first laser radiation source 1 which, in example, is a mode-locked Nd-YAG solid state laser. Its beam λ lies in the infrared wavelength region, 1064 nm in the present example, its pulse width is 4 ps at a pulse repetition frequency of 120 MHz. This beam λ, is split, wherein the first part is frequency-doubled when passing through a first crystal SHG₁ of LBO or KTP or BBO and green light results with a wavelength of 532 nm. Additional parts are used for generating light of primary colors red and blue as will be described in the following.

According to the invention, a second beam λ₂ is generated in the infrared wavelength region from the original beam λ₁ by means of a Raman wavelength converter. In the example, the Raman wavelength converter comprises a P-doped fiber provided with Bragg reflectors (see, e.g., Karpov, V. I., “Laser-diode pumped Raman laser”, Optics Letters, Jul. 1, 1999, Vol. 24, No. 13, 887-889). The second beam ₂ has a wavelength of 1560 nm, likewise with a pulse width of 4 ps at a pulse repetition frequency of 120 MHz.

Further, the second beam λ₂ is also split, wherein a first part of the second beam ₂ with a second part of the first beam λ₁ is supplied to a second crystal SMF₁ of a first sum frequency mixing in a KTA crystal or LBO crystal or KNbO₃ crystal, so that red light with a wavelength of 632 nm results.

Further, a second part of the second beam λ₂ is frequency doubled in a third crystal SHG₂ and this frequency-doubled beam λ₃ with a wavelength of 780 nm with a third part of the first beam λ₁ is supplied to a fourth crystal SFM₂ of KNbO₃ or KTP or LBO for a second sum frequency mixing, so that blue light with a wavelength of 450 nm results.

The pulses of the two laser radiation sources or their frequency-doubled pulses must coincide with respect to their geometric and temporal dimensions in the nonlinear crystals in which they collide and both pulses must be phase-matched in order to achieve an efficient frequency mixing. The temporal overlapping of the two pulses is realized by adjusting the optical path lengths in the beam path before the spatial combination of the laser beams in front of each nonlinear crystal in which the sum frequency mixing is carried out. For this purpose, in the example, an optical delay 3, 4 is arranged in the beam path of wavelength ₁ in front of every nonlinear crystal for sum frequency mixing SFM₁ and SFM₂.

Further, the two beams must be superimposed with respect to their geometric extent and orientation in every case within the nonlinear crystals for sum frequency mixing SFM₁ and SFM₂. This is effected by means of the known arrangement of mirrors and lenses in the beam path of the two laser beams with which the sum frequency mixing is carried out. Phase matching of the pulses is achieved by making use of the anistropy of each nonlinear crystal, generally through crystal orientation.

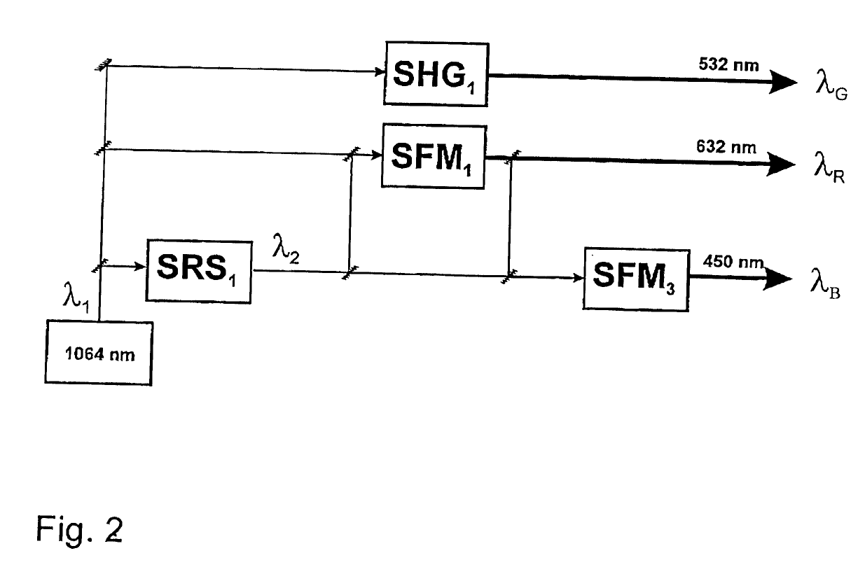

FIG. 2 shows an R-G-B laser radiation source which works with only three crystals for wavelength transformation. It comprises a laser radiation source, in the present example, an Nd-based fiber laser, whose beam λ₁ lies in the infrared wavelength range. This beam is split by a splitting mirror, wherein the first part of the beam is frequency-doubled in the first crystal SHG₁ resulting in green light with a wavelength of 532 nm. A second part is used for generating light of the primary color blue.

According to the invention, a third laser beam λ₁ is shifted in the wavelength range λ₂. This second beam is also split by a splitting mirror, wherein a first part of the second beam λ₂ in the infrared wavelength region with the second part of the first beam λ₁ is supplied to the second crystal SMF₁ for the first sum frequency mixing and red light with wavelength 632 nm results.

This red light is split by another splitting mirror. A part of the red light is available for further processing at an output of the R-G-B laser and the other part is used for generating the color blue. For this purpose, a second part of the second beam λ₂ with one part of the red light is supplied to another crystal SFM₃ of LBO or KNbO₃ for further sum frequency mixing and blue light with a wavelength of 450 nm results. Both lasers are operated as continuous-wave lasers. The nonlinear crystals are constructed in this instance as poled structures.

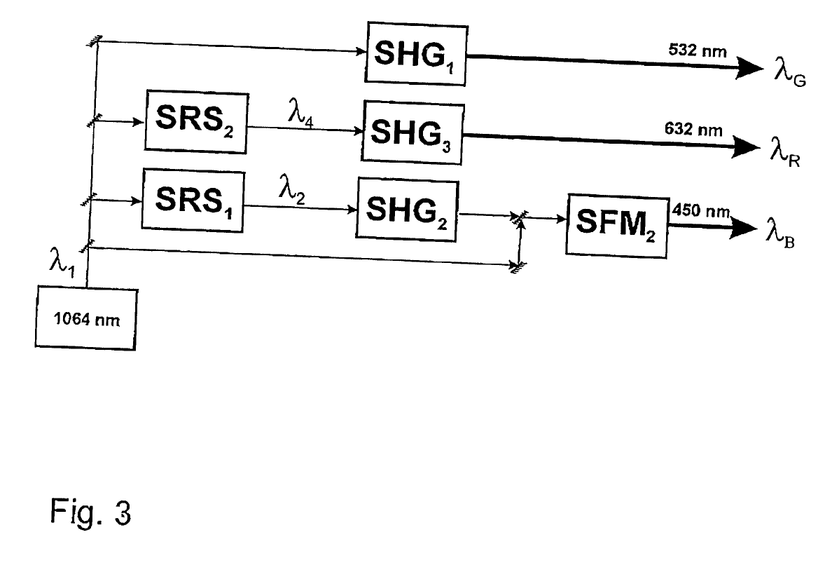

FIG. 3 shows a R-G-B laser radiation source with two Raman wavelength converters SRS₁ and SRS₂ and with four crystals for wavelength transformation corresponding to the solution in FIG. 1.

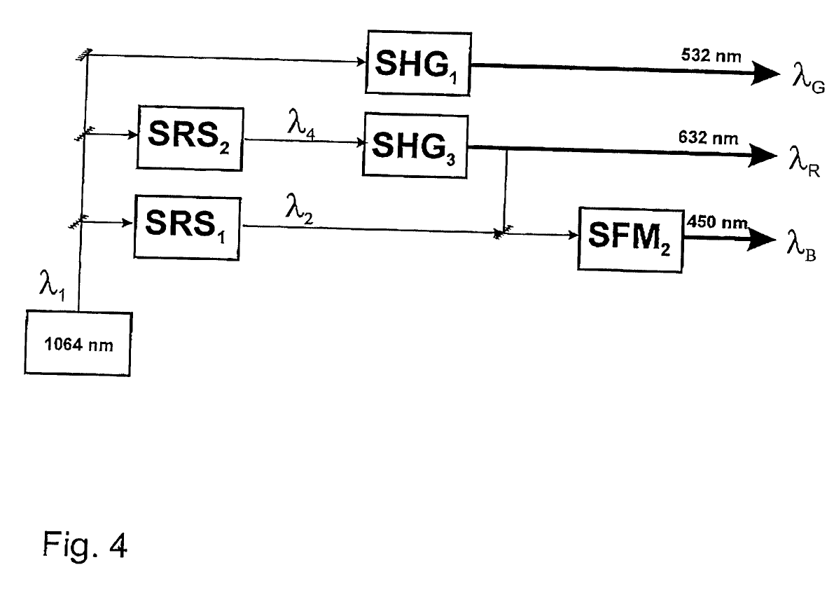

FIG. 4 shows an R-G-B laser radiation source with two Raman wavelength converters SRS₁ and SRS₂ and with three crystals for wavelength transformation corresponding to the solution in FIG. 2.

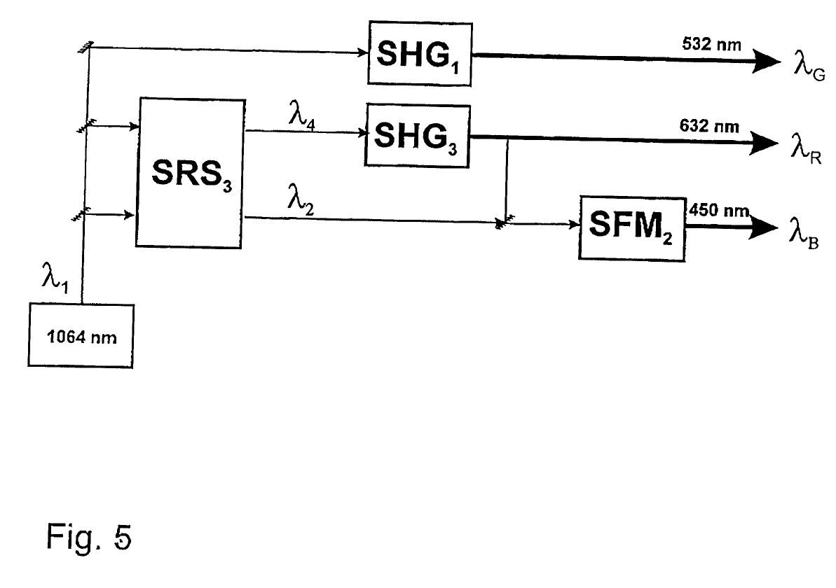

FIG. 5 shows an R-G-B laser radiation source with a Raman wavelength converter SRS₃ which is operated on two wavelengths λ₂ and λ₄. The wavelength transformation corresponds to that in FIG. 4. A Raman wavelength converter SRS₃ of this kind can also be used for the solution in FIG. 3.

While the foregoing description and drawings represent the present invention, it will be obvious to those skilled in the art that various changes may be made therein without departing from the true spirit and scope of the present.

What is claimed is:

1. An arrangement for generating red, green and blue laser radiation comprising:
a laser radiation source whose first beam (λ₁) is split in the infrared wavelength range, wherein the first part of this beam is frequency-doubled and green light (λ_{G}) results and another part is used to generate light of the primary colors red (λ_{R}) and blue (λ_{B});
another part of the first beam (λ_{I}) being fed to a wavelength converter which generates another beam (λ₂, λ₄) in the infrared wavelength range which has a greater wavelength than the first beam (λ₁); and
the colors red (λ_{R}) and blue (λ_{B}) resulting from the further beam (λ₂, λ₄) or from a part thereof by another nonlinear process by sum frequency mixing or by frequency doubling or by sum frequency mixing and frequency doubling.

2. The arrangement according to claim 1, wherein a second part of the first beam (λ₁)is fed to a first wavelength converter which generates a second beam (λ₂), further, the color blue (λ_{B}) results from a part of the second beam (λ₂) or a part thereof by sum frequency mixing with a part of the red beam (λ_{R}).

3. The arrangement according to claim 1, wherein a second part of the first beam (λ₁) is fed to a first wavelength converter which generates a second beam (λ₂), a third beam (λ₃) is generated from the second beam (λ₂) or a part thereof by mean s of frequency doubling and the color blue (λ_{B}) results by sum frequency mixing of the third beam (λ₃) with a third part of the first beam (λ₁).

4. The arrangement according to claim 3, wherein the color red (λ_{R}) results from a part of the second beam (λ₂) by sum frequency mixing with a fourth part of the first beam (λ₁).

5. The arrangement according to claim 2, wherein a fifth part of the first beam (λ₁) is fed to a second wavelength converter which generates a fourth beam (λ₄), further the color red (λ_{R}) results from the fourth beam (λ₄).

6. The arrangement according to claim 3, wherein a part of the first beam (λ₁) is fed to one individual wavelength converter which generates the second beam (λ₂) and the fourth beam (λ₄).
